(19) United States
(12) Patent Application Publication
(10) Pub. No.: US 2020/0359221 A1
(43) Pub. Date: Nov. 12, 2020

(54) IDENTIFICATION AND CONTROL OF PERMISSIBLE ROBOCALLING ON INGRESS TO A TELECOMMUNICATIONS NETWORK

(71) Applicant: Level 3 Communications, LLC, Broomfield, CO (US)

(72) Inventor: Adam C. Uzelac, Rochester, NY (US)

(73) Assignee: Level 3 Communications, LLC, Broomfield, CO (US)

(21) Appl. No.: 16/810,597

(22) Filed: Mar. 5, 2020

Related U.S. Application Data
(60) Provisional application No. 62/846,349, filed on May 10, 2019.

(51) Int. Cl. H04W 12/08; G06F 16/28; H04W 12/10; H04L 29/06; H04L 12/721

(52) U.S. Cl. CPC H04W 12/0808; G06F 16/285; H04L 45/72; H04L 69/22; H04W 12/1006

(57) ABSTRACT

A robocall management system is provided that identifies, classifies, and routes one or more robocalls on ingress into a telecommunications network. In some instances, a robocall may be received at an ingress point of the network and analyzed by the robocall management system. Analysis of the received call may access one or more types of identification, such as an identification token, and classify the robocall as permissible or impermissible based on the identification data. Additionally, the robocall management system may monitor a rate of received robocalls from a known robocall customer and compare the rate of robocalls made to a CPS threshold value associated with the customer. One or more routing actions may be executed on a received robocall based on the classification, including routing the robocall to the destination, selecting a routing path via the receiving network, and/or blocking the robocall at the ingress device.

### CROSS-REFERENCE TO RELATED APPLICATION

This application is related to and claims priority under 35 U.S.C. § 119(e) from U.S. Patent Application No. 62/846,349, filed May 10, 2019 entitled “IDENTIFICATION AND CONTROL OF PERMISSIBLE ROBOCALLING ON INGRESS TO TELECOMMUNICATIONS NETWORK,” the entire contents of which is incorporated herein by reference for all purposes.

### TECHNICAL FIELD

Embodiments of the present invention generally relate to systems and methods for implementing a telecommunications network, and more specifically for identifying and controlling automatic voice communications (or robocalling) via a telecommunications network.

### BACKGROUND

Telecommunication networks provide for the transmission of information across some distance through terrestrial, wireless or satellite communication networks. Such communications may involve voice, data or multimedia information, among others. In some instances, customers of a telecommunications network may use the network to disseminate a pre-recorded message from a computerized auto-dialer to a large number of recipients, sometimes referred to as a “robocall”. Robocalls may be used to provide any kind of pre-recorded message to a large group of receivers, such as public-service messages, emergency announcements, school closures announcements, etc. To initiate the robocalls, a user of the network may program a computing device to autodial multiple receiving communication devices and play the prerecorded information when the call is connected at the receiving device. Through the robocalls, information may be provided to a large segment of a population without requiring a person or group of people to place each call individually.

In some instances, however, robocalls may be made with malicious intent or be otherwise aggravating to a person receiving the robocall. For example, telemarketers may use robocalls in an attempt to sell goods over the phone, which can quickly overwhelm a person's communication device with unwanted calls. In other examples, the recorded message played at the beginning of a robocall may be designed to obtain secret or personal information, such as a receiver's social security number or bank information, to appropriate the receiver's identity. In still other examples, robocalls may be used as part of a denial of service (DOS) attack on a networking device by exploiting the autodialing feature of the robocalling computing device to direct multiple calls at a target to overwhelm that target's communication ports. Distinguishing legitimate uses of the robocall capability of a telecommunications network from the illegitimate uses may aid the network in preventing or reducing ill-intentioned robocalls and improving the experience of users of the network from receiving unwanted robocalls.

It is with these observations in mind, among others, that aspects of the present disclosure were conceived.

### SUMMARY

One aspect of the present disclosure relates to a method for operating a telecommunications network. The method may include the operations of receiving, at a first network device, a communication associated with an auto-dialing computing device and comparing an identification block of data accessed from one or more signaling fields of the received communication to a database of robocall identifiers. The method may further include classifying, based on the comparison of the identification block of data accessed from one or more signaling fields of the received communication, the received communication, the classification indicating a permissibility of the received communication as a robocall and routing, based on the classification, the received communication via a network.

Another aspect of the present disclosure relates to a networking device comprising a processor, a communication port receiving, via a trunk group connected to a network, a communication associated with an auto-dialing computing device, and a non-transitory memory comprising instructions encoded thereon. The instructions, when executed by the processor, may be operable to classify, based on a comparison of an identification block of data accessed from one or more signaling fields of the received communication to a database of robocall identifiers, the received communicate as a type of a robocall communication, the classification indicating a permissibility of the received communication as a robocall and route, based on the classification of the permissibility of the robocall communication, the received communication via the network.

Yet another aspect of the present disclosure relates to a robocall management system and a database storing identification data associated with an auto-dialing computing device connected to a network via a trunk group. The network device may comprise a processor, a communication port receiving, via a trunk group connected to a network, a communication associated with an auto-dialing computing device, and a non-transitory memory comprising instructions encoded thereon. The instructions, when executed by the processor, may be operable to classify, based on a comparison of an identification block of data accessed from one or more signaling fields of the received communication to a database of robocall identifiers, the received communicate as a type of a robocall communication, the classification indicating a permissibility of the received communication as a robocall and route, based on the classification of the permissibility of the robocall communication, the received communication via the network.

### BRIEF DESCRIPTION OF THE DRAWINGS

The various features and advantages of the technology of the present disclosure will be apparent from the following description of particular embodiments of those technologies, as illustrated in the accompanying drawings. It should be noted that the drawings are not necessarily to scale; however the emphasis instead is being placed on illustrating the principles of the technological concepts. The drawings depict only typical embodiments of the present disclosure and, therefore, are not to be considered limiting in scope.

FIG. 1 schematic diagram illustrating an exemplary Internet Protocol (IP) operating environment in accordance with one embodiment.

FIG. 2 is a schematic diagram illustrating a robocall management system for managing robocalls received at a communications network.

FIG. 3 is a flowchart illustrating a method for identifying, classifying, and processing robocalls received at a communications network.

FIG. 4 is a flowchart illustrating a method routing a robocall based on identifying a classification of the robocall.

FIG. 5 is a diagram illustrating an example of a computing system which may be used in implementing embodiments of the present disclosure.

### DETAILED DESCRIPTION

Aspects of the present disclosure involve systems, methods, and the like, for identifying and controlling one or more robocalls on ingress into a telecommunications network. In some instances, a robocall identification system may identify and classify robocalls received at the network based on one or more identification schemes and, based on the classification of the received robocalls, route the robocall via the receiving network or block the call. For example, a robocall may be received at an ingress point of the network and analyzed by a robocall management system. Analysis of the received call may access one or more types of identification, such as a token, a data portion, a source Internet Protocol (IP) address, or any other identification data to determine the received call is a robocall. Further, the identification data may be used to classify the robocall as permissible or impermissible by the robocall management system. Additionally, the robocall management system may monitor a rate of received robocalls (such as calls per second (CPS)) from a known robocall customer and compare the rate of robocalls made to a CPS threshold value associated with the customer. Based on any number of the identification data and/or the comparison of the rate of robocalls made to the CPS threshold, a received robocall may be classified by the system. In one example, a robocall may be classified as permissible, impermissible, or indeterminate.

In some instances, one or more routing actions may be executed on a received robocall based on the classification associated with the robocall. For example, a received robocall that is categorized as legitimate may be routed to the destination communication device as dialed. In some instances, the destination device of the robocall may be determined and an identifier indicating the robocall as legitimate may be attached to or otherwise associated with the robocall based on the destination. For example, robocalls intended for a network other than the receiving network, or a destination device associated with a network other than the receiving network, may be associated with the legitimate identifier for use by the other network in routing. For robocalls categorized as indeterminate, a routing path via the receiving network may be selected. The alternate routing path may include routing based on a least cost basis or may include routing to a platform to conduct further analysis of the robocall to determine the intent of the robocall. Robocalls that are characterized as illegitimate may be blocked at the ingress device of the receiving network or otherwise controlled to prevent delivery of the robocall to the destination device. In this manner, a robocall management system of a telecommunications network may identify and control routing of robocalls received at the network.

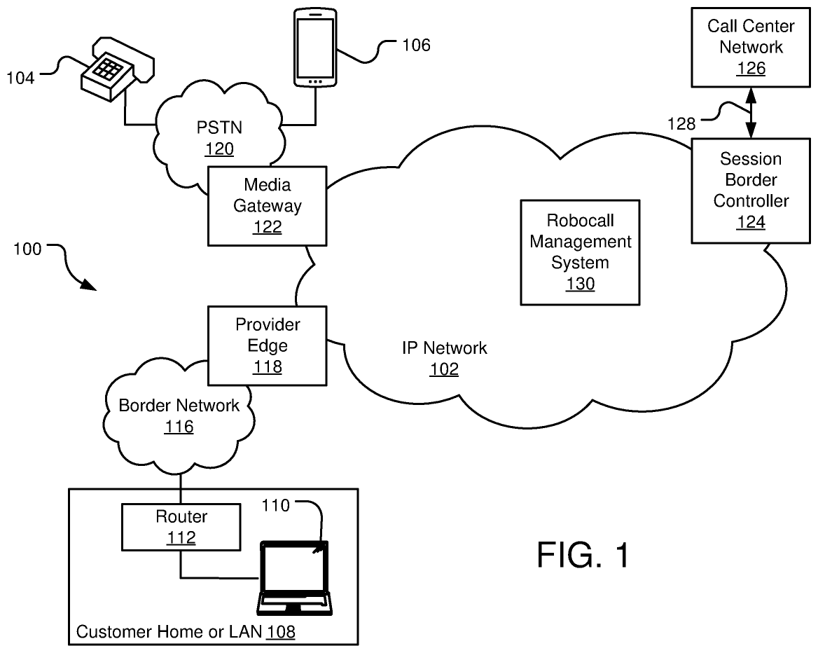

FIG. 1 illustrates an exemplary operating environment 100 for distributing routes to routing devices within a network based on one or more network policies. In general, the environment 100 provides for establishing communication sessions between network users and for providing one or more network services to network users. For example, users may utilize the network 102 to communicate via the network using communication devices, such as telephone devices 104 and/or mobile communication devices 106. In another example, the network environment 100 may facilitate communications between networks managed or administered by separate entities, such as communications between IP network 102 and call center network 126. With specific reference to FIG. 1, the environment 100 includes an IP network 102, which may be provided by a wholesale network service provider. However, while the environment 100 of FIG. 1 shows a configuration using the IP network 102, it should be appreciated that portions of the network may include non IP-based routing. For example, network 102 may include devices utilizing time division multiplexing (TDM) or plain old telephone service (POTS) switching. In general, the network 102 of FIG. 1 may include any communication network devices known or hereafter developed.

The IP network 102 includes numerous components such as, but not limited to gateways, routers, route reflectors, and registrars, which enable communication and/or provides services across the IP network 102, but are not shown or described in detail here because those skilled in the art will readily understand these components. The IP network 102 may also include a robocall management system to identify and route one or more robocalls received from call center network 126, as discussed in more detail below. Communications between the IP network 102 and other entities or networks, such as the one or more customer home or business local area networks (LANs) 108, may also be managed through network environment 100.

Customer network 108 can include communication devices such as, but not limited to, a personal computer or a telephone 110 connected to a router/firewall 112. Although shown in FIG. 1 as computer 110, the communication devices may include any type of communication device that receives a multimedia signal, such as an audio, video or web-based signal, and presents that signal for use by a user of the communication device. The communication and networking components of the customer network 108 enable a user at the customer network to communicate via the IP network 102 to other communication devices, such as another customer network and/or the call center network 126. Components of the customer network 108 are typically home- or business-based, but they can be relocated and may be designed for easy portability. For example, the communication device 110 may be wireless (e.g., cellular) telephone, smart phone, tablet or portable laptop computer. In some embodiments, multiple communication devices in diverse locations that are owned or operated by a particular entity or customer may be connected through the IP network 102.

The customer network 108 typically connects to the IP network 102 via a border network 116, such as one provided by an Internet Service Provider (ISP). The border network 116 is typically provided and maintained by a business or organization such as a local telephone company or cable company. The border network 116, also referred to as a peer network, may provide network/communication-related services to their customers. Other communication devices, such as telephonic device 104 and/or mobile device 106, may access and/or be accessed by, the IP network 102 via a public switched telephone network (PSTN) 120 operated by a local exchange carrier (LEC). Communication via any of the networks can be wired, wireless, or any combination thereof. The telephonic device 104, mobile device 106, and/or computing device 110 may further utilize the IP network 102 to communicate with or otherwise access the call center network 126 to provide and obtain data.

Call center network 126 may connect to IP network 102 through a dedicated trunk group connection 128. In other words, the call center network 126 may request and receive a trunk group connection 128 to the IP network 102 that includes multiple connection lines into the network that is not shared with other customers to the IP network. Services and/or support for the call center network 126 may be provided by the IP network 102 through application of the services on each communication received via the dedicated trunk group 128 as each communication must be provided to the IP network 102 from the call center network 126. In some instances, the call center network 126 may include one or more computing devices configured or programmed to generate robocalls to the IP network 102 via trunk group 128. The computing devices of the call center network 126 may be any type of computing device configured to autodial a pre-programmed telephone number associated with a destination communication device, such as cellular phone 106 or customer device 110. The autodialed communication, or robocall, may be provided to the destination device as described in more detail. Once connected, a pre-recorded message may be played over the connection between the communication devices by the robocall computing device of the call center network 126. In this manner, the computing devices of the call center network 126 may place multiple robocalls via trunk group 128 to any destination devices connected or accessible via the IP network 102.

Networks, such as the call center network 126, border network 116, and/or PSTN 120, may connect to IP network 102 through one or more interface or edge devices. Interface devices may include, but are not limited to, provider edge device 118, media gateway device 122, and/or session border controller 124. For ease of instruction, only three external networks 126, 116, and 120 are shown communicating with the IP network 102; however, numerous such networks, and other devices, may be connected with the network 102, which is equipped to handle enormous numbers of simultaneous calls and/or other IP-based communications.

As mentioned, IP network 102 may include a robocall management system 130 for identifying and processing robocalls provided to the IP network 102 from call center network 126 via session border controller (SBC) 124. In some instances, the components and functions of the robocall management system 130 may be incorporated or executed by SBC 124 upon ingress of robocalls from the call center network 126 via trunk group 128. In other instances, robocall management system 130 may be embodied on one or more components of network 102, such as one or more application servers or other networking devices of the network 102. In general, all or portions of the robocall management system 130 may be included in any component of the IP network 102 or associated with the network. In still another example, the robocall management system 130 may not be included in the IP network 102. Rather, the robocall management system 130 may connect to or otherwise communicate with trunk group 128 to receive the robocalls from the call center network 126 to identify and process the robocalls.

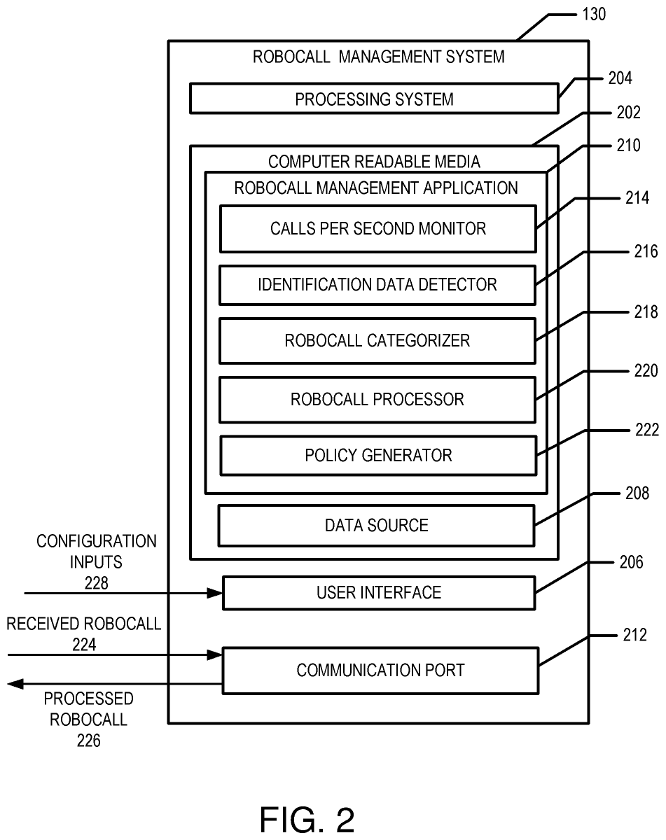

FIG. 2 is a schematic diagram illustrating a robocall management system 130 for managing robocalls received at a communications network 102. The robocall management system 130 of FIG. 2 may be the robocall management system 130 for managing robocalls received at network 102 from call center network 126 via trunk group 128. In some instances, a robocall management application 210 may be executed on the robocall management system 130 to perform one or more of the operations described herein. The robocall management application 204 may be stored in a computer readable media 202 (e.g., memory) and executed on a processing system 204 of the robocall management system 130 or other type of computing system, such as that described below. For example, the security management application 204 may include instructions that may be executed in an operating system environment, such as a Microsoft Windows™ operating system, a Linux operating system, or a UNIX operating system environment. The computer readable medium 202 includes volatile media, nonvolatile media, removable media, non-removable media, and/or another available medium. By way of example and not limitation, non-transitory computer readable medium 202 comprises computer storage media, such as non-transient storage memory, volatile media, nonvolatile media, removable media, and/or non-removable media implemented in a method or technology for storage of information, such as computer readable instructions, data structures, programs, or other data.

According to one embodiment, the robocall management system 130 also provides a user interface (e.g., a command line interface (CLI), a graphical user interface (GUI), etc.) 206 displayed on a display, such as a computer monitor, for displaying data. Through the user interface 206, a user of the robocall management system 130 may provide configuration inputs 228 through one or more input devices. The configuration inputs 228 may be used to, among other things, configure the components of the robocall management application 210, set or alter one or more threshold values used by the robocall management application to identify and/or categorize a received robocall, define or configure aspects of methods of robocall identifications, define or configure aspects of robocall categorizations, define or configure aspects of routing robocalls based on call categorization, and the like. The input device for providing the configuration inputs 228 may include, among others, a keyboard or a pointing device (e.g., a mouse, trackball, pen, or touch screen) to enter data into or interact with the user interface 206. The user interface 206 may be accessed from any computing device in communication with the robocall management system 130. Thus, a user or administrator of the robocall management system 130 or the IP network 102 may log into the robocall user interface 206 remotely to provide the configuration inputs 228 or to otherwise manage the robocall management system 130.

The robocall management application 210 may also utilize a data source 208 of the computer readable media 202 for storage of data and information associated with the robocall management system 130. For example, the robocall management application 210 may store information associated with the operations of the robocall management system 130, including threshold values for identifying robocalls from a call center network 126, identification data or tokens for comparison to data received in one or more robocalls, characterization tags or identifiers for inclusion in signaling data of a received robocall, and the like. The data source 208 may also include IP network 102 infrastructure information, such as edge devices 124 connected or associated with call center network 126, trunk group identifications associated with call center customers, access information for edge devices of the network, traffic flow or routing information, and the like. In general, any aspect of the infrastructure and interconnectivity of the components of the IP network 102 may be stored in the data source 208 or otherwise available to the robocall management system 130 for use in processing received robocalls at the network.

The robocall management system 130 may also include one or more communication ports through which robocalls 224 intended for or received at the SBC 124 of the IP network 102 are received. For example, call center network 126 may generate one or more robocalls 224 transmitted to SBC 124 via trunk group 128 for transmission to a destination device connected to or otherwise available via the IP network 102. The robocall management system 130 may receive the robocall from the trunk group 128 by connecting to the trunk group, as part of the SBC 124 as the robocall is received via the trunk group 128, or routed from the SBC 124 to the robocall management system 130. In some instances, each communication transmitted from the call center network 126 via the trunk group 128 may be considered a received robocall 224 by the robocall management system 130. Further, received robocalls 224 may be processed by the robocall management system 130 as described herein to execute some type of action on the received robocall, including routing the robocall based on a categorization of the received call, blocking the robocall, tagging the robocall with a categorization identifier, and the like. The robocall management system 130 may utilize the communication port 212 to transmit the processed robocall 226 for routing to one or more destinations as described herein. In some instances, the robocall management system 130 may transmit one or more routing instructions via the communication port 212 to one or more components of the IP network 102 to execute the particular routing action based on the processing of the robocall.

In addition, the robocall management application 210 may include several components to perform one or more of the operations described herein. For example, the robocall management application 210 may include a calls per second (CPS) monitor to obtain or retain a CPS policy associated with the call center network 126 and compare a rate of received robocalls 224 from the call center network to the CPS policy. Thus, the CPS policy for the call center network 126 may include a threshold CPS value. The threshold CPS value may be agreed upon in a contract between an administrator of the call center network 126 and an administrator of the IP network 102. For example, the call center network 126 may be associated with a CPS policy that limits the call center network 126 to less than 12 calls per second. In some instances, the IP network 102 may disregard or block robocalls exceeding the CPS threshold for the call center network 126. In other instances, exceeding the CPS threshold rate may trigger warnings or other alarms, but the robocalls from the call center network 126 may be continue to be received and processed at the IP network 102. The robocall management system 130 may determine the number of received robocalls 224 from the call center network 126 every second and compare the number of calls received over the last second to the CPS policy threshold value. As discussed in more detail below, exceeding the CPS threshold value may indicate a malicious or undesirable robocall or plurality of robocalls from the call center network 126 and such calls may be routed accordingly.

An identification data detector 216 may also be included in the robocall management application 210. The identification data detector 216 may analyze one or more bits of signaling data included in or otherwise associated with a received robocall 226 for the presence of identification data, an identification token, an originating IP address, a destination IP address, and the like. In particular, the call center network 126 may be configured to include identification data in one or more aspects of the signaling or routing data of transmitted robocalls to the IP network 102. The identification data may include, but is not limited to, encrypted and unencrypted strings of alphanumeric data within the Session Initiation Protocol (SIP) header (such as within a host portion of the SIP Uniform Resource Identifier (URI) or some other header, encrypted or unencrypted strings of bits in a routing header, an indication of an IP source address associated with the call center network 126, and the like. One or more components of the call center network 126, such as autodialing computing devices, may be configured to include or insert the identification data into robocalls initiating from the call center network. The identification data may be known by the identification data detector 216 of the robocall management application 210 such that a verification of the presence of the identification data associated with a received robocall 224 may be performed.

The robocall management application 210 may also include a robocall categorizer 218 categorizing received robocalls 224 into any number of categories for routing decisions of a robocall. For example, received robocalls 224 may be categorized into “permissible”, “indeterminate”, and/or “impermissible” robocalls by the robocall categorizer 218. The scheme by which the robocall categorizer 218 determines a robocall category for a received robocall 224 is discussed in more detail below. The robocall categorizer 218 may also include or otherwise associate one or more categories with a received robocall 224 for further processing and routing of the call. For example, the robocall categorizer 218 may insert a tag or string of data into a header portion of the robocall 224 to categorize the call as “permissible” by the robocall management system 130. Other tags or strings of data associated with a received robocall 224 may indicate other categories in which the robocall is classified. In still another instance, the robocall management application 210 may maintain a table of entries indicating robocalls and associated categories, such as in the data source 208 of the robocall management system 130 and process a categorized robocall 224 according to the maintained table of entries.

A robocall processor 220 may also be included in the robocall management application 210 to process received robocalls 224 based on the categorization discussed above. The robocall processor 220 may determine one or more actions or routes to apply to a particular robocall 224 based on the associated category or categories. Such actions may include permitting routing of the robocall 224 into IP network 102, re-directing the robocall to another component of the IP network for further analysis, selecting a low-cost route through IP network 102, and/or blocking the robocall 224 from further routing through the IP network 102. Robocalls 224 that are permitted for routing or re-directed may be transmitted from the robocall management system 130 via communication port 212. The actions undertaken by the robocall processor 220 may be included or determined by policy generator 222 of the application 210. The policy generator provides one or more actions to be executed by the robocall management application 210 or system 130 based on the processing of the received robocalls 224. In one example, the policy generator 222 may determine the actions applied to a processed robocall from configuration inputs 228 provided to the application 210 via the user interface 206. As such, the policies for robocalls may be stored in data source 208 for use by the policy generator 222. In other examples, the policy generator 222 may generate one or more policy rules or actions to associate with the identification and categorization of robocalls 224 received from the call center network 126 based on any number of previously received policies, previously processed robocalls 224, IP network 102 performance measurements, and the like.

It should be appreciated that the components described herein are provided only as examples, and that the application 210 may have different components, additional components, or fewer components than those described herein. For example, one or more components as described in FIG. 2 may be combined into a single component. As another example, certain components described herein may be encoded on, and executed on other computing systems, such as on one remotely coupled to the robocall management system 130.

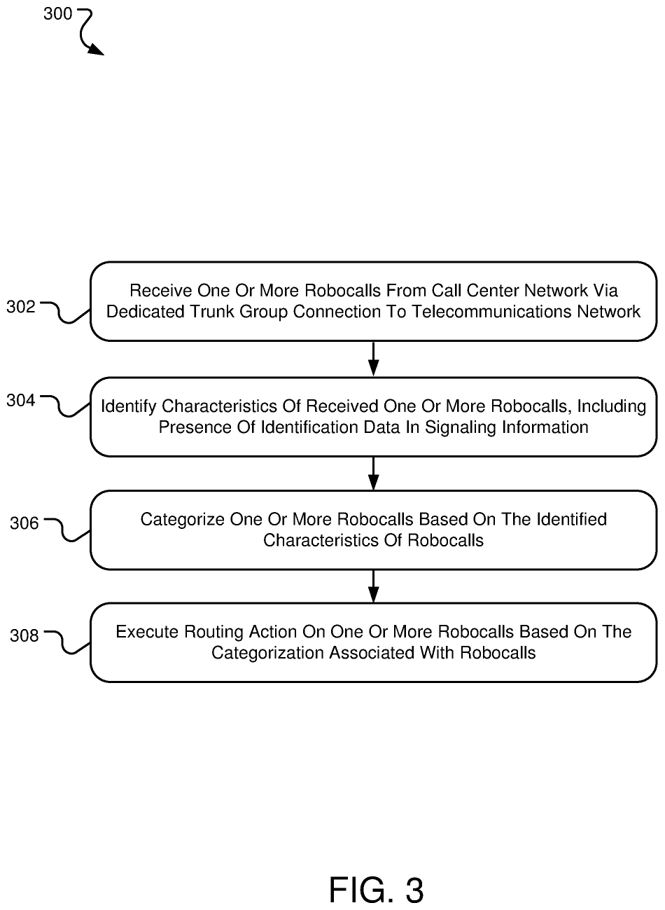

Through the robocall management application 210, the robocall management system 130 may identify, classify or categorize, and route one or more received robocalls to the network 102. In particular, FIG. 3 is a flowchart illustrating a method 300 for identifying, classifying, and processing robocalls received at a communications network 102. In one instance, the operations of the method 300 of FIG. 3 may be performed by the robocall management system 130. In other instances, the operations of the method 300 may be performed by other components of the telecommunications network 102, components separate from the telecommunications network 102 but otherwise associated with the call center network 126, or a combination of components of both the telecommunications network and/or the call center network. In addition, the operations may be performed by any number of hardware components or circuits, any number of software programs, or a combination of both hardware and software components.

Beginning in operation 302, the robocall management system 130 may receive one or more robocalls from the call center network 126 via the trunk group 128 connection to the IP network 102. The robocalls may originate from an auto-dialing computing device configured to generate robocalls and transmit the robocalls to the SBC 124 edge device to the network 102. As mentioned above, robocalls may be generated for various purposes, including public-service messages, emergency announcements, school closures announcements, etc. Thus, call center network 126 may generate and provide these legitimate robocalls to the network 102 for dissemination to other communication devices associated with the network 102. In some instances, however, the call center network 126 may also provide or be configured to provide illegitimate robocalls, such as for phishing schemes or DOS attacks on devices of or associated with the network 102.

In some instances, the auto-dialer computing devices of the call center network 126 may be configured to insert an identification token or other block of data into the signaling information associated with generated robocalls. For example, the auto-dialer may insert an identification token comprising a string of alphanumeric characters, a string of bits, etc. into a SIP header, such as into a SIP URI or other aspect of the SIP header, of a generated robocall. The identification data may be encrypted by the auto-dialer or may be inserted as unencrypted data. In general, any type of identification data may be inserted into or otherwise associated with a generated robocall by the auto-dialer. The identification data may also be known by the robocall management system 130 such that the system may detect the presence of the identification data in the header of the robocall communication. In operation 304, the robocall management system 130 may identify one or more characteristics of a received robocall to determine a legitimacy of the received robocall. In one example, the characteristics of the received robocall may include the identification data discussed above, encrypted or unencrypted, included in the signal information of the robocall, such as in the SIP header or other SIP signaling block of data. In another example, the robocall management system 130 may identify a source identification address of the robocall, such as a source IP address, source Media Access Control (MAC) address, or any other identifier of a source device of the robocall communication. The auto-dialer generating the robocall may be associated with the source identification address and may include the address in some aspect of the communication that may be identified by the robocall management system 130. One or more of the identification data may be compared to a database of known robocall information. For example and as explained in more detail below, the robocall may include an identification token that may be compared to a database of identification tokens associated with the trunk group connecting to the network. Other identification information, such as an encryption scheme, source IP address, MAC address, and the like may be stored in a database for reference by the robocall management system 130.

In another example, the robocall management system 130 may determine a rate of robocalls generated by the call center network 126, such as a calls per second (CPS) rate of received calls. To determine the CPS, the robocall management system 130 may monitor and track the number of received robocalls over a previous second to determine a current CPS. The CPS may be compared to a CPS threshold value associated with the call center network 126. For example, the IP network 102 and/or the robocall management system 130 may associate a CPS threshold value to all communications originating from the call center network 126. This threshold value may be a portion of service agreement between the call center network 126 and the IP network 102 to delineate a level of service provided to the call center network based on a call flow rate. In one example, the CPS threshold value for the call center network 126 may be 12 ls per second, although any threshold value may be agreed upon. While the call center network 126 may, in some instances, exceed the CPS threshold value, robocalls made that exceed the threshold value may generate a higher price to route, may be routed in an alternate manner, may be stored and routed at a time when the CPS of the received calls is below the threshold value, and the like. The robocall management system 130 may store the CPS threshold value for a call center network 126 or trunk group 128 and compare a current CPS to the threshold value continually to determine if the rate of received robocalls from the call center network 126 meets or exceeds the CPS threshold value.

In operation 306, the robocall management system 130 may categorize one or more of the received robocalls based on the identified characteristics of the robocalls determined above. For example, robocalls received at the robocall management system 130 that include identification data in the SIP header that matches a known identification data for the call center network 126 may be categorized by the system 130 as a legitimate or permissible robocall. In another example, robocalls received at the robocall management system 130 that do not exceed the CPS threshold value for the call center network 126 may be categorized as a permissible or legitimate robocall. However, received robocalls that do not exceed the CPS threshold value for the call center network 126 but do not include the identification data in the header may be categorized as “indeterminate” or otherwise indicated as unknown as to the authenticity of the robocall. In general, any combination of the identification characteristics of the robocalls from the call center network 126 may indicate a “permissible” category or “indeterminate” category by the robocall management system 130. For example, only robocalls including a legitimate source identification address, the known identification data in a header field, and are within the CPS threshold value for the call center network 126 may be categorized as legitimate or permissible by the robocall management system 130. Robocalls including one or more, but not all, characteristics may be categorized as indeterminate by the system 130. In general, any number of characteristics may correspond to any type and number of categories for robocalls received at the robocall management system 130.

In another example, robocalls that lack one or more of the identifying characteristics may be categorized as impermissible robocalls by the robocall management system 130. Thus, robocalls that do not include the identifying data in the header information of the communication or exceed the CPS threshold value associated with the call center network 126 may be categorized as impermissible. In other examples, a received robocall may be categorized as impermissible if the robocall lacks all of the identifying characteristics noted above. In addition, the robocall management system 130 may label or otherwise insert an indicator of the category assigned to a robocall into some aspect or field of the robocall. For example, the robocall management system 130 may insert a tag into a header field of a robocall that is categorized as permissible that other components of the network 102 or any other networking component may use to allow, route, or otherwise process the robocall. The permissible tag may comprise any conditional identifier, such as a string of bits, which may be included in the header or otherwise associated with a communication. In one instance, the tag may be a standardized communication condition that may be processed and identified by other networking components or devices.

In operation 308, the robocall management system 130 may execute one or more routing procedures or actions on a received robocall based on a category associated with the robocall determined above. For example, the robocall management system 130 may route a robocall categorized as permissible to a destination device of the network 102 or associated with the network as indicated in a destination address included in the routing information of the header of the communication. In some instances, routing a permissible robocall may include inserting a tag or other identifier into a header field that indicates to other networking devices that the robocall is verified. In another example, a robocall categorized as indeterminate may be routed to the destination address via the network 102, but an alternate routing path through the network may be implemented for the robocall. Such an alternate path may include a least cost route that minimizes the impact of the routing of the robocall on the components and processing of the network 102. In another example, robocalls categorized as indeterminate may be routed to one or more additional network components for additional scrutiny, processing, or other determination of the validity or permissibility of the received robocall. In still another example, robocalls categorized as impermissible may be blocked from transmission through network 102 or may be routed through a separate network. In general, any routing action may be implemented on a received robocall based on the category associated with the robocall determined above.

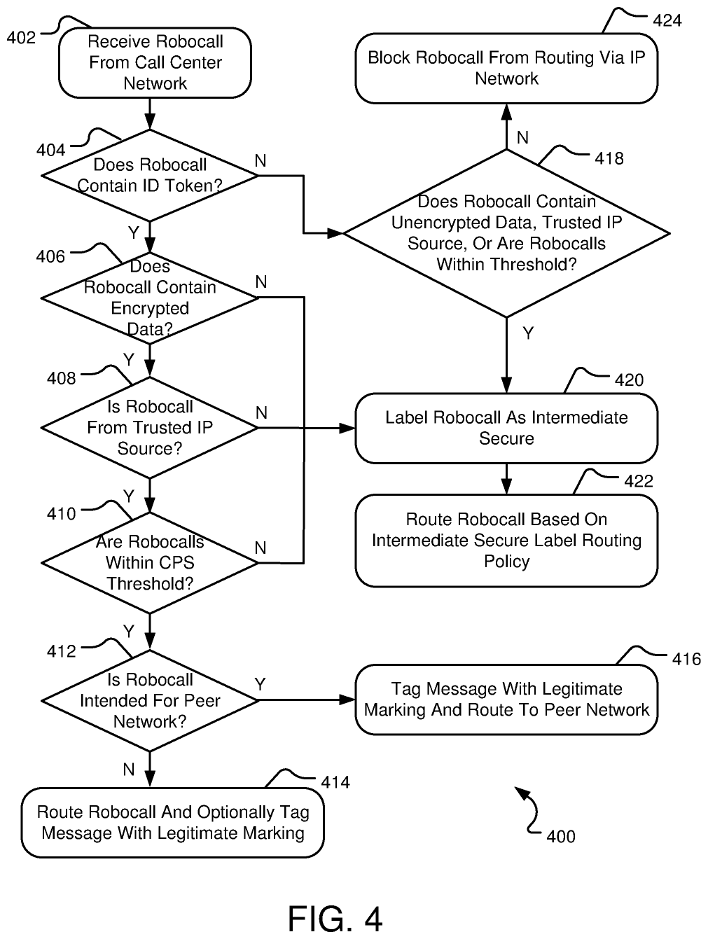

Through the method 300 of FIG. 3, the robocall management system 130 may identify, categorize, and process robocalls received at a network 102 to determine which robocalls are permissible and which robocalls may be made with some malicious intent. The processing or routing of the robocalls may prevent malicious or annoying robocalls from reaching one or more destination devices to improve customer use of the network 102. FIG. 4 illustrates a specific method 400 for routing a robocall based on identifying a classification or category associated with the robocall. Aspects of the operations of the method 400 are discussed above in relation to the robocall management system 130 such that the method may illustrate one specific example of the operations of the robocall management system. The operations of the method 400 may thus be performed by the robocall management system 130. In some instances, however, the operations may be performed by other components of the telecommunications network 102, components separate from the telecommunications network 102 but otherwise associated with the call center network 126, or a combination of components of both the telecommunications network and/or the call center network. In addition, the operations may be performed by any number of hardware components or circuits, any number of software programs, or a combination of both hardware and software components.

Beginning in operation 402, the robocall management system 130 may receive a robocall from a call center network 126. In one implementation, the call center network 126 may connect to an IP network 102 via a trunk group 128 connection over which the robocall may be transmitted to the robocall management system 130. In operation 404, the robocall management system 130 may determine if the received robocall contains an identification token. As mentioned above, the identification token may be a string of alphanumeric characters or string of bits included in the signaling information of the robocall. In one example, the SIP header may include an identification token. The identification token may be known by the robocall management system 130 prior to receiving the robocall such that the system can compare the known data to the identification token in the robocall header. For example, the identification token may be stored in a database of identification information. Upon receipt of the robocall, the robocall management system may compare the obtained identification from the robocall with the stored identification token to determine if they are the same. In another example, the database may store a source IP address, a MAC address, an encryption scheme (such as an encryption key or other encryption information) in the database for use in comparing to the information of the received robocall for comparison. In general, the robocall management system 130 may be configured to search for any known identification token in the header of the communication.

The robocall management system 130 may, if the robocall includes the identification token, further determine if the robocall contains an encrypted data block in the signaling information of the communication. In particular, the robocall management system 130 may be configured to decrypt one or more portions of the signaling information of the received robocall using a pre-programmed encryption/decryption scheme included in the database. The encryption scheme may be shared with the call center network 126 such that encryption of the data in the signaling information may be executed by a computing device at the call center network and decryption may occur at the robocall management system 130. If the robocall includes the encrypted data block, the robocall management system 130 may determine if the robocall includes a trusted IP source address as the originating source of the robocall in operation 408. In particular, the robocall management system 130 may maintain in the database or receive a list of trusted IP or other types of source addresses. The list of trusted IP addresses may be provided to the robocall management system 130 by the IP network 102 or from another trusted source. Upon receiving a robocall, the management system 130 may determine an identification of a source address, such as a source IP address, and compare the source address in the robocall to the list of trusted source IP addresses.

If the robocall includes an identification of a trusted source address, the robocall management system 130 may determine, in operation 410, if the robocall is within a CPS threshold value associated with the call center network 126 from which the robocall originated or is received. As described above, the network 102 may monitor the CPS rate of received robocalls from the call center network 126. The robocall management system 130 may compare a current CPS (or a number of received robocalls from the call center network 126 in the previous second) to a threshold CPS value associated with the call center network 126. If the received robocall does not cause the call center network 126 to exceed the CPS threshold value, the robocall management system 130 may determine, in operation 412, if the received robocall is intended for a destination device of a peer network or is intended for a destination device of the IP network 102. If the robocall is not intended for a destination device of a peer network, the robocall management system 130 may route the robocall to the destination device as a legitimate or permissible robocall. In some instances, the robocall management system 130 may insert into or otherwise alter header information of the robocall to include a tag that identifies the robocall as legitimate to other networking or computing devices in operation 414. If the robocall management system 130 is intended for a destination device of a peer network, the system 130 may insert into or otherwise alter the header information of the robocall to include a tag marking the robocall as a legitimate or permissible robocall in operation 416. One or more networking or computing devices of the peer network may utilize the inserted tag to make routing decisions of the robocall on the path to the destination device.

If the robocall is determined to not include the identification token in operation 404, the robocall management system 130 may determine in operation 418 if the robocall includes unencrypted identification data, a trusted source address, or does not meet or exceed the CPS threshold value for the call center network 126. If any of the conditions apply in operation 418, the robocall management system 130 may categorize the robocall as indeterminate in operation 420. Additionally, if the robocall management system 130 determines the robocall does not include the encrypted data in operation 406, or does not include a trusted source address in operation 408, or exceeds the CPS threshold value for the call center network 126 in operation 410, the robocall management system 130 may categorize the robocall as indeterminate in operation 420. In some instances, the robocall management system 130 may insert or otherwise associate a categorization tag with the robocall indicating the “indeterminate” category associated with the robocall. In operation 422, the robocall management system 130 may route the robocall based on the indeterminate category associated with the robocall. As explained above, routing of indeterminate robocalls may include selecting an alternate path through the network for the robocall, such as along a least cost route, routing to one or more additional components of the network 102 for analysis, further categorization, additional labeling, and the like. In general, any aspect of routing of a communication through a network 102 may be executed by the robocall management system 130 in routing a robocall labeled or categorized as indeterminate.

Returning to operation 418, the robocall management system 130 may determine that the robocall does not include any identifying information and exceeds the CPS threshold value for the call center network 126. In such circumstances, the robocall management system 130 may categorize the robocall as impermissible and execute one or more routing schemes based on the impermissible category in operation 424. For example, the robocall management system 130 may block the robocall from further routing via the IP network 102. In another example, the robocall management system 130 may route the robocall to the destination device, but log information identifying aspects of the robocall for further processing by the network. In still another example, the robocall management system 130 may route the robocall to a networking device of the IP network 102 configured to accept impermissible robocalls and perform some action, such as playing a recording to the source device or taking any of the actions described above.

The method 400 of FIG. 4 is but one example of operations performed by the robocall management system 130 to identify, categorize, and process robocalls received at a network 102 to determine which robocalls are permissible and which robocalls may be made with some malicious intent. The robocall management system 130 may use any combination of the identification schemes, call categories, and routing actions discussed herein.

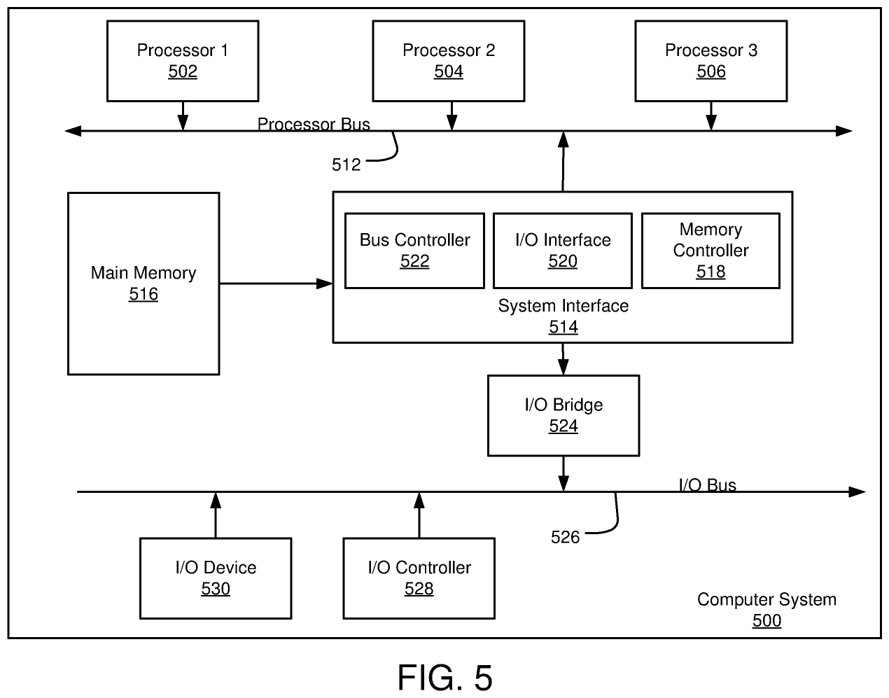

FIG. 5 is a block diagram illustrating an example of a computing device or computer system 500 which may be used in implementing the embodiments of the components of the network disclosed above. For example, the computing system 500 of FIG. 5 may be the robocall management system 130 discussed above. The computer system (system) includes one or more processors 502-506. Processors 502-506 may include one or more internal levels of cache (not shown) and a bus controller or bus interface unit to direct interaction with the processor bus 512. Processor bus 512, also known as the host bus or the front side bus, may be used to couple the processors 502-506 with the system interface 514. System interface 514 may be connected to the processor bus 512 to interface other components of the system 500 with the processor bus 512. For example, system interface 514 may include a memory controller 514 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system set forth in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or programs utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

We claim:

1. A method for operating a telecommunications network, the method comprising:
receiving, at a first network device, a communication associated with an auto-dialing computing device;
comparing an identification block of data accessed from one or more signaling fields of the received communication to a database of robocall identifiers;
classifying, based on the comparison of the identification block of data accessed from one or more signaling fields of the received communication, the received communication, the classification indicating a permissibility of the received communication as a robocall; and
routing, based on the classification, the received communication via a network.

2. The method of claim 1, further comprising:
inserting, into a header associated with the received communication, an identifier of the type of permissibility for the classified received communication.

3. The method of claim 1, further comprising:
monitoring a rate of a plurality of communications received from the auto-dialing computing device over a period of time; and
wherein the classification of the received communication is further based on a comparison of the rate of a plurality of communications received from the auto-dialing computing device over the period of time to a rate of received communications threshold value associated with the auto-dialing computing device.

4. The method of claim 1, wherein the identification block is encrypted by the auto-dialing computing device prior to transmitting to the first network device.

5. The method of claim 4, wherein the identification block comprises an identification token associated with the auto-dialing computing device, the identification token unique to the auto-dialing computing device as stored in the database of robocall identifiers.

6. The method of claim 1, wherein the classification indicating the permissibility of the received communication as a robocall is at least one of a trusted robocall, an unknown robocall, or an untrusted robocall.

7. The method of claim 1, wherein routing the received communication comprises transmitting the received communication to a network device for logging of the identification block of data and the classification indicating the permissibility of the received communication as a robocall.

8. The method of claim 1, wherein the identification block comprises an Internet Protocol (IP) source address associated with the auto-dialing computing device and the classification indicating the permissibility of the received communication is further based on the IP source address.

9. A networking device comprising:
a processor;
a communication port receiving, via a trunk group connected to a network, a communication associated with an auto-dialing computing device; and
a non-transitory memory comprising instructions encoded thereon, the instructions, when executed by the processor, are operable to:
classify, based on a comparison of an identification block of data accessed from one or more signaling fields of the received communication to a database of robocall identifiers, the received communicate as a type of a robocall communication, the classification indicating a permissibility of the received communication as a robocall; and
route, based on the classification of the permissibility of the robocall communication, the received communication via the network.

10. The networking device of claim 9 wherein the identification block comprises an identification token associated with the auto-dialing computing device, the identification token unique to the auto-dialing computing device as stored in the database of robocall identifiers.

11. The networking device of claim 9 wherein the identification block is encrypted by the auto-dialing computing device, the instructions further operable to:
de-crypt, utilizing an encryption key stored in the database, the encrypted identification block prior to the comparison of the identification block of data accessed from the one or more signaling fields of the received communication to the database of robocall identifiers.

12. The networking device of claim 9 wherein the identification block comprises a source network address associated with the auto-dialing computing device and the classification indicating the permissibility of the received communication is further based on the IP source address.

13. The networking device of claim 9 wherein the instructions are further operable to:
monitor a rate of a plurality of communications received from the auto-dialing computing device over a period of time; and
wherein the classification of the received communication is further based on a comparison of the rate of a plurality of communications received from the auto-dialing computing device over the period of time to a rate of received communications threshold value associated with the auto-dialing computing device.

14. The networking device of claim 9 wherein the classification indicating the permissibility of the received communication as a robocall comprises a trusted robocall indicator, the instructions further operable to:
insert, into a header associated with the received communication, an identifier of the type of permissibility for the classified received communication, wherein routing the received communication via the network is based on the inserted identifier.

15. The networking device of claim 9 wherein the classification indicating the permissibility of the received communication as a robocall comprises an indeterminate robocall indicator and routing the received communication via the network comprises:
selecting a least cost route via the network; and
routing the received communication based on the least cost route.

16. The networking device of claim 9 wherein the classification indicating the permissibility of the received communication as a robocall comprises an untrusted robocall indicator and routing the received communication via the network comprises:
transmitting the received communication to a network device for logging of the identification block of data and blocking of the received communication.

17. A robocall management system comprising:
a database storing identification data associated with an auto-dialing computing device connected to a network via a trunk group; and
a network device comprising:
a processor;
a communication port receiving, via the trunk group, a communication associated with the auto-dialing computing device; and
a non-transitory memory comprising instructions encoded thereon, the instructions, when executed by the processor, are operable to:
classify, based on a comparison of an identification block of data accessed from one or more signaling fields of the received communication to the database, the received communicate as a type of a robocall communication, the classification indicating a permissibility of the received communication as a robocall; and
route, based on the classification of the permissibility of the robocall communication, the received communication via the network.

18. The robocall management system of claim 17 wherein the instructions of the network device are further operable to:
monitor a rate of a plurality of communications received from the auto-dialing computing device over a period of time; and
wherein the classification of the received communication is further based on a comparison of the rate of a plurality of communications received from the auto-dialing computing device over the period of time to a rate of received communications threshold value associated with the auto-dialing computing device.

19. The robocall management system of claim 17 wherein the identification data of the database comprises at least one of an identification token unique to the auto-dialing computing device, an encryption key associated with the auto-dialing computing device, or source network address associated with the auto-dialing computing device.

20. The robocall management system of claim 17 wherein the classification indicating the permissibility of the received communication as a robocall is at least one of a trusted robocall, an unknown robocall, or an untrusted robocall.
